(19) United States
(12) Patent Application Publication
(10) Pub. No.: US 2009/0290180 A1
(43) Pub. Date: Nov. 26, 2009

(54) PRINTING SYSTEM, PRINTING APPARATUS, COMPUTER-READABLE STORAGE MEDIUM, AND CALIBRATION METHOD

(75) Inventor: Hitoshi Onoda, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/465,965

(22) Filed: May 14, 2009

(30) Foreign Application Priority Data
May 22, 2008 (JP) 2008-134652

(51) Int. Cl. H04N 1/60

(52) U.S. Cl. 358/1.9

(57) ABSTRACT

A printing system controls a printing unit to print one or a plurality of patches on a printing medium, and measures the colors of the patches. The printing system controls the printing unit to print information based on the colorimetry results of the patches in correspondence with the patches, thereby forming the first chart.

### BACKGROUND OF THE INVENTION

1. Field of the Invention

The present invention relates to a calibration technique for suppressing fluctuations of the color reproduction characteristic.

2. Description of the Related Art

There is known a printing apparatus (e.g., printer) which prints using C, M, Y, and K inks, toners, or the like. Such a printing apparatus adopts a technique of stabilizing not only C, M, Y, and K primary colors, but also secondary colors such as red, green, and blue, and tertiary and quadratic colors which form gray lines. For example, there is known a technique of adjusting the tints of Nth-order colors (Japanese Patent Laid-Open No. 2006-86969). According to this technique, a color printer prints a patch chart of Nth-order colors, and a colorimeter measures the colors of the patch chart. The output values of grid points in a multi-dimensional look-up table for adjustment are corrected based on the colorimetry results.

There is also known a technique of adjusting a partial color tint (Japanese Patent Laid-Open No. 2000-203094). According to this technique, the operator confirms patches one by one in a patch chart printed by a printer of interest and a patch chart printed by a calibration printer. The operator designates a patch having a large difference. The printing profile is partially updated in accordance with the designated patch.

However, the conventional techniques suffer the following problems.

For example, when performing calibration based on a multi-dimensional look-up table using a calorimeter, a patch chart including all the color gamuts of a printing apparatus is printed to measure the color. This takes the same time duration and consumes the same amount of ink as those when generating a color profile again.

To efficiently execute calibration, it is preferable to limit color gamuts to be adjusted, print only a patch chart corresponding to the limited color gamuts, and measure the color. When limiting color gamuts, the following two criteria need to be satisfied:
Color gamuts are limited to only those which fluctuate greatly (from previous adjustment).
Color gamuts are limited to only those the user wants.

It is not efficient to print, measure, and correct the patch of a color gamut whose color tint has hardly fluctuated from a standard state or previous calibration. Such a color gamut is appropriately excluded from adjustment targets. It is also inefficient to print and measure the patch of a color gamut, fluctuations of which do not matter to the user, and that of a color gamut not used in subsequent printing. Such a color gamut is also properly excluded from adjustment targets.

To make a determination for meeting these two criteria, for example, the user needs to satisfy the following conditions:
The user needs to grasp the fluctuation amount of a given color gamut from a standard state or previous calibration.
The user needs to determine a color gamut to be adjusted or not, and reflect the determination result.

To grasp the fluctuation amount of a given color gamut, the user has to execute the following operations:
1. Print the patches of all color gamuts.
2. Measure the color with a calorimeter.
3. Calculate the color difference of each patch.
4. Confirm the correspondence between the color difference calculation result and each patch.

It is very cumbersome to grasp the fluctuation amount of a given color gamut. The user has to make the color difference calculation result and the color tint of a patch correspond to each other, so an operation error readily occurs.

Further, to determine the necessity/unnecessity of adjustment for each color gamut in accordance with the correspondence between the color difference calculation result and each patch, and reflect the determination result, the user needs to “5. manually input a color gamut to be adjusted” (Japanese Patent Laid-Open No. 2000-203094). It is very troublesome to input adjustment targets one by one into a computer. In addition, an input error readily occurs.

### SUMMARY OF THE INVENTION

The present invention provides a printing system, printing apparatus, computer-readable storage medium, and calibration method for printing a patch chart which allows the user to easily grasp color fluctuations in each color gamut.

According to a first aspect of the present invention, there is provided a printing system including a printing apparatus having a printing unit which prints on a printing medium, the system comprising: a patch print control unit configured to control the printing unit to print at least one patch on the printing medium; a colorimetry unit configured to measure a color of the patch which has been printed on the printing medium under control of the patch print control unit; and a colorimetry-result print control unit configured to control the printing unit to print information based on a colorimetry result of the patch by the colorimetry unit in correspondence with the patch on the printing medium, thereby forming a first chart.

According to a second aspect of the present invention, there is provided a printing apparatus having a printing unit which prints on a printing medium, the apparatus comprising: a patch print control unit configured to control the printing unit to print at least one patch on the printing medium; a colorimetry unit configured to measure a color of the patch which has been printed on the printing medium under control of the patch print control unit; and a colorimetry-result print control unit configured to control the printing unit to print information based on a colorimetry result of the patch by the colorimetry unit in correspondence with the patch on the printing medium, thereby forming a chart.

According to a third aspect of the present invention, there is provided a computer-readable storage medium storing a computer program, the program causing a computer incorporated in a printing apparatus having a printing unit which prints on a printing medium, to function as a patch print control unit configured to control the printing unit to print at least one patch on the printing medium, and a colorimetry-result print control unit configured to control the printing unit to print, in correspondence with the patch on the printing medium, information based on a colorimetry result of the patch by a calorimeter incorporated in the printing apparatus, thereby forming a chart.

According to a fourth aspect of the present invention, there is provided a calibration method for a printing unit which prints on a printing medium, the method comprising: controlling the printing unit to print at least one patch on the printing medium; measuring a color of the patch which has been printed on the printing medium in the controlling the printing unit; and controlling the printing unit to print, in correspondence with the patch on the printing medium, information based on a colorimetry result of the patch measured in the measuring a color of the patch, thereby forming a chart.

Further features of the present invention will become apparent from the following description of exemplary embodiments with reference to the attached drawings.

### BRIEF DESCRIPTION OF THE DRAWINGS

FIG. 1 is a block diagram showing an example of the configuration of a printing system configured by arranging a printer to which a printing apparatus according to the present invention is applied;

FIG. 2 is a perspective view showing an example of the structures of a print engine 6, calorimeter 7, and sensor 8 shown in FIG. 1;

FIG. 3 is a flowchart showing an example of the whole sequence of print processing in a printer 100 shown in FIG. 1;

FIG. 4 is a flowchart showing an example of the sequence of calibration 3D LUT update processing;

FIG. 5 is a view showing an example of the layout of a confirmation chart;

FIG. 6 is a flowchart showing an example of the sequence of confirmation chart print processing in step S101 shown in FIG. 4;

FIG. 7 is a view showing a schematic RGB color space;

FIG. 8 is a view showing part of the schematic RGB space shown in FIG. 7;

FIG. 9 is a flowchart showing an example of the sequence of adjustment color gamut determination processing in step S103 shown in FIG. 4; and

FIG. 10 is a flowchart showing an example of the sequence of corrected-data generation processing in step S104 shown in FIG. 4.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

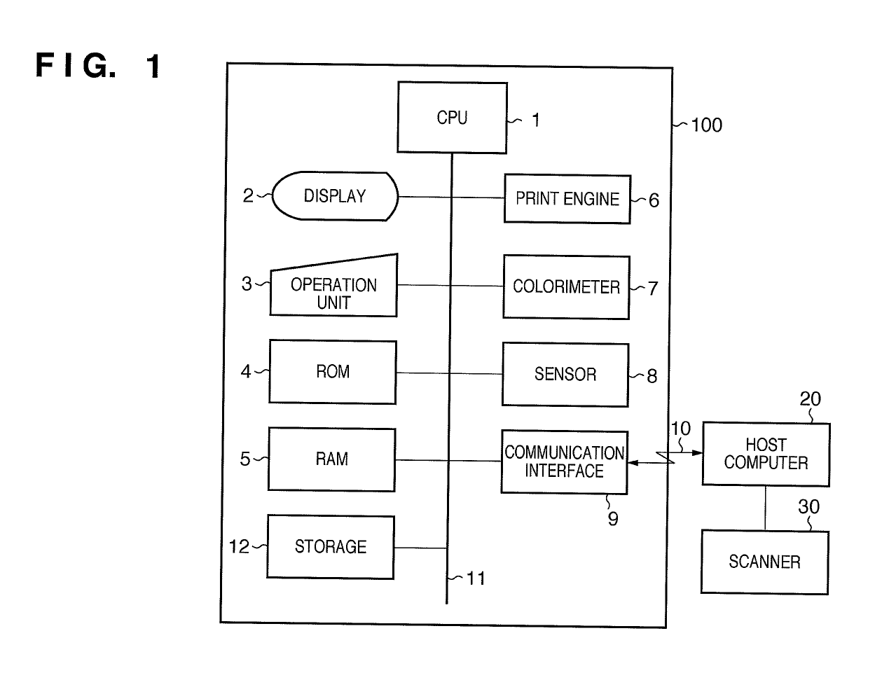

FIG. 1 is a block diagram showing an example of the configuration of a printing system configured by arranging a printer to which a printing apparatus according to the present invention is applied.

The printing system includes a printer 100, host computer 20, and scanner 30.

The printer 100 prints on a printing medium such as paper based on print data. For example, the host computer 20 inputs print data.

The printer 100 includes a CPU 1, display 2, operation unit 3, ROM 4, RAM 5, print engine 6, calorimeter 7, sensor 8, and communication interface 9.

The CPU 1 controls the overall operation of the printer 100. The CPU 1 controls each unit connected via a bus 11 in accordance with a program stored in the ROM 4 and data stored in a storage 12. At this time, the CPU 1 uses the RAM 5 as a work area.

The calorimeter 7 incorporates, for example, a spectrometer or a measurement device using a predetermined optical filter. The calorimeter 7 reads the color of a color patch formed on paper, and outputs CIE L*, a*, and b* values or the like as calorimetric values.

The display 2 includes a liquid crystal panel or the like, and displays various kinds of information to the operator. The operation unit 3 includes a button, switch, and the like, and inputs an instruction from the operator into the apparatus.

The sensor 8 optically detects the presence/absence of paper, the end position of paper, and the like. The storage 12 includes a flash memory, hard disk, or the like, and stores data which need to be updated, that is, data which need to be rewritten.

The print engine 6 includes a printhead, feed roller, and the like, and prints by discharging ink onto a printing medium such as paper. The embodiment will explain an inkjet print engine 6. However, the present invention is not limited to this, and is also applicable to another method such as a toner (electrophotographic) method.

The communication interface 9 includes a USB (Universal Serial Bus) board, LAN (Local Area Network) board, or the like, and interfaces exchange of data between the printer 100 and an external device. In this case, the communication interface 9 is connected via a communication line 10 to the host computer 20 connected to the scanner 30.

The host computer 20 is a computer apparatus operated by the operator. For example, the host computer 20 generates print data based on an instruction from the operator, and inputs it to the printer 100 via the communication line 10 and communication interface 9.

The scanner 30 is an image reading apparatus which scans a figure, photograph, text, or the like from a document and converts it into digital data. The scanner 30 is of the flatbed type, sheet feeder type, or the like, and scans a figure or the like from a document.

An example of the configuration of the printing system has been described. The arrangement of the printer 100 shown in FIG. 1 is merely an example, and the printer 100 is not limited to this. For example, the storage 12 may also be arranged outside the printer 100.

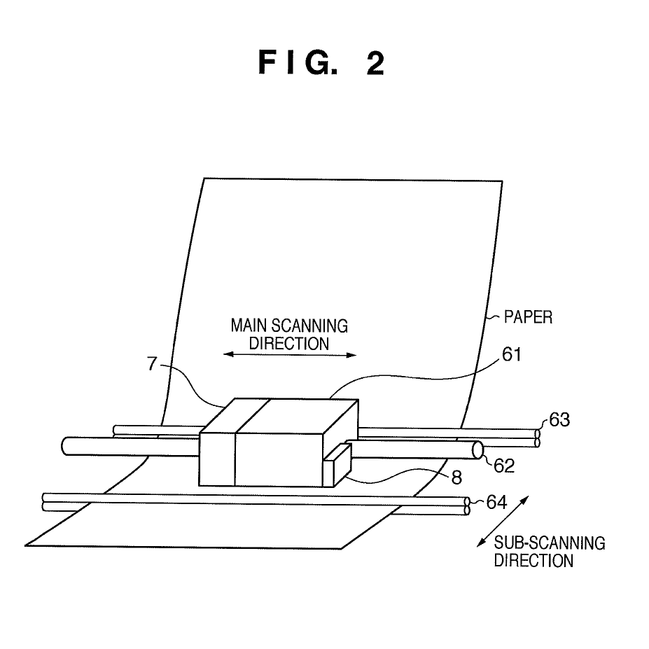

FIG. 2 is a perspective view showing an example of the structures of the print engine 6, calorimeter 7, and sensor 8 shown in FIG. 1.

A printhead 61 supports heads (not shown) for discharging C, M, Y, and K inks. The printhead 61 is arbitrarily driven along a shaft 62 by a timing belt and motor (neither is shown). That is, the printhead 61 moves in the main scanning direction. Paper is conveyed in the sub-scanning direction by feed rollers 63 and feed rollers 64.

The printhead 61 supports the calorimeter 7. The calorimeter 7 is driven in the main scanning direction together with the printhead 61. When paper is fed in the sub-scanning direction, the calorimeter 7 can measure a color at an arbitrary position on the paper. In many cases, the use of the built-in calorimeter 7 can reduce the cost more than the use of a calorimeter arranged as a separate device outside the printer 100.

The printhead 61 also supports the sensor 8. Similar to the calorimeter 7, the sensor 8 is driven in the main scanning direction together with the printhead 61. When paper is fed in the sub-scanning direction, the sensor 8 detects the presence/absence of paper and the end position of paper.

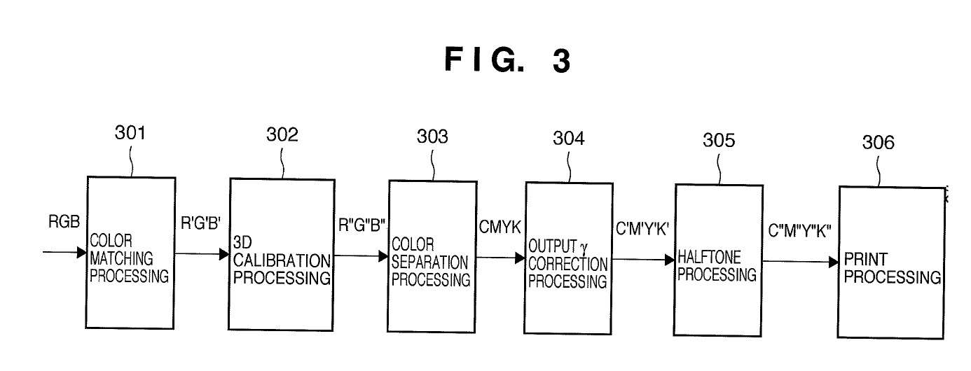

An example of the whole sequence of print processing (particularly image processing) in the printer 100 shown in FIG. 1 will be explained with reference to FIG. 3. For example, the CPU 1 operates in accordance with a program and data stored in the ROM 4 and storage 12 using the RAM 5 as a work area, thereby executing this processing.

The processing starts when the printer 100 receives R, G, and B print data generated by the host computer 20. After the processing starts, the printer 100 performs color matching processing 301. The color matching processing 301 makes the color reproduction characteristics of R, G, and B input image data match the printer colors. In this processing, color matching is achieved by performing 3D interpolation processing such as tetrahedral interpolation processing or cubic interpolation processing for R, G, and B image data. As a result, R′, G′, and B′ color-converted data are output.

In 3D calibration processing 302, the R′, G′, and B′ data obtained by the color matching processing 301 are calibrated by 3D interpolation processing such as tetrahedral interpolation processing or cubic interpolation processing based on the contents of a multi-dimensional look-up table. As a result, R″, G″, and B″ color-converted data are output. Note that the storage 12 stores in advance the multi-dimensional (3D in this embodiment) look-up table (to be simply referred to as a 3D LUT hereinafter).

In color separation processing 303, the R″, G″, and B″ data are separated into colors by 3D interpolation processing such as tetrahedral interpolation processing or cubic interpolation processing in order to convert the R″, G″, and B″ data into the ink colors of the printer 100. In the embodiment, the ink colors of the printer 100 are four, C (Cyan), M (Magenta), Y (Yellow), and K (black).

In output γ correction processing 304, the C, M, Y, and K data undergo γ correction processing in accordance with a combination of the contents of halftone processing 305 and the print engine 6. In the halftone processing 305, C′, M′, Y′, and K′ multilevel data are converted into tone levels (binary data or the like) which can be expressed by the print engine 6.

In print processing 306, the print engine 6 drives the printhead based on the C″, M″, Y″, and K″ data having undergone the halftone processing 305. The print engine 6 discharges ink to form an image on the paper surface.

The whole sequence of print processing in the printer 100 has been described. In the embodiment, the contents of the 3D calibration processing 302 are optimized by updating the contents of the calibration 3D LUT stored in the storage 12. This stabilizes the tints of secondary and higher-order colors on a printed material.

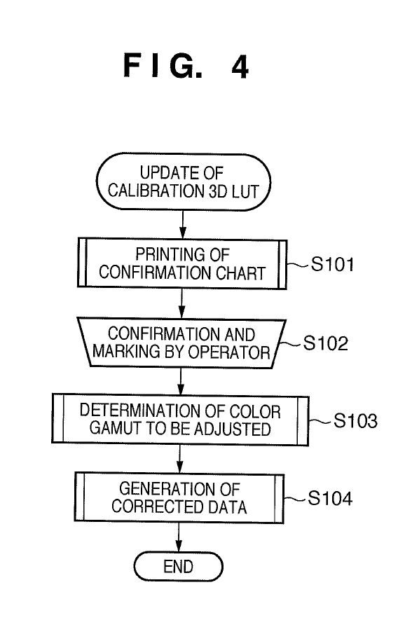

Calibration 3D LUT update processing will be explained with reference to FIG. 4. For example, the CPU 1 operates in accordance with a program and data stored in the ROM 4 and storage 12 using the RAM 5 as a work area, thereby executing this processing.

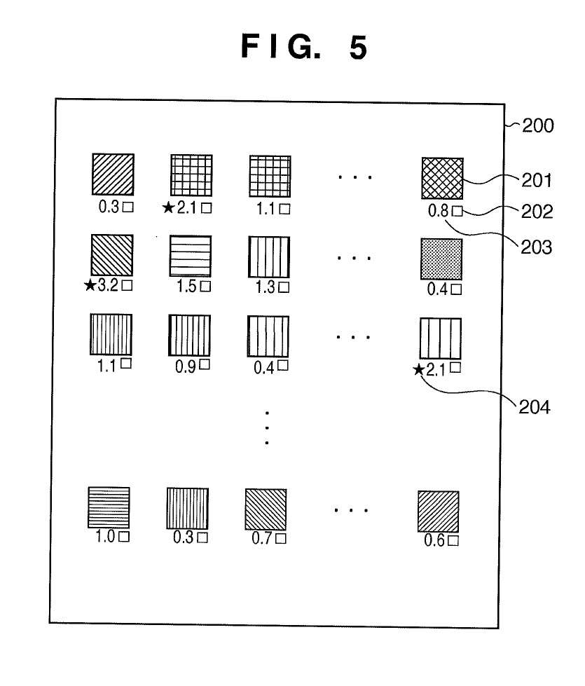

To confirm the fluctuation amount of a given color gamut, the printer 100 prints a confirmation chart as the first chart (step S101). The CPU 1 controls the print engine 6 to print the confirmation chart. The confirmation chart has, for example, a layout shown in FIG. 5. As shown in FIG. 5, a confirmation chart 200 has patches which typify a plurality of color gamuts. In a predetermined range from each patch (in this case, immediately below each patch), information (to be referred to as colorimetry result information hereinafter) based on the result of measuring the color gamut of the patch is printed in correspondence with the patch. As the colorimetry result information, for example, information (information representing the color tint or color difference of each patch or the like) on the fluctuation amount of a corresponding color gamut from a reference state is printed. In a predetermined range from each patch (in this case, immediately below each patch), an entry area to be marked by the operator is also printed in correspondence with the patch. In the entry area, the operator describes the necessity/unnecessity of a patch for a color gamut.

In the confirmation chart 200, not only patches which typify a plurality of color gamuts, but also patches of many colors may also be laid out. For example, many patches representing all the color gamuts of a printer may also be laid out. In this case, colorimetry result information is printed in correspondence with each patch so that the user can grasp the states of colors in all the color gamuts. Alternatively, patches of similar colors may also be laid out around a patch which typifies each color gamut. In this case, colorimetry result information is printed in correspondence with each patch so that the user can confirm in detail reproduced colors near a color gamut of interest.

When patches which typify a plurality of color gamuts, and other patches are printed on a single chart, entry areas to be marked by the operator may also be printed only near the patches which typify a plurality of color gamuts.

Referring back to FIG. 4, when the confirmation chart is printed, the operator visually confirms it, and selects a patch corresponding to a color gamut to be adjusted (step S102). For example, based on colorimetry result information printed on the confirmation chart, the operator selects the patch of a color gamut which greatly fluctuates and needs to be adjusted. A color gamut which is not used in subsequent printing though its patch greatly fluctuates may also be excluded from adjustment targets. The operator marks an entry area provided in correspondence with the patch of a color gamut determined to be adjusted, by filling the entry area with a pen or putting a checkmark in it. Alternatively, the operator may also mark an entry area provided in correspondence with the patch of a color gamut determined not to be adjusted.

After confirming patches and making entry areas, the operator sets the confirmation chart in the printer 100. The printer 100 feeds the marked confirmation chart, and executes adjustment color gamut determination processing based on the description contents of the confirmation chart (step S103). This processing determines a color gamut for which the calibration 3D LUT is to be updated.

After a color gamut for which the calibration 3D LUT is to be updated is determined by the processing in step S103, the printer 100 prints, as the second chart, a corrected chart in which patches corresponding to the color gamut are laid out. The printer 100 updates the calibration 3D LUT based on the result of measuring the colors of patches on the corrected chart (step S104).

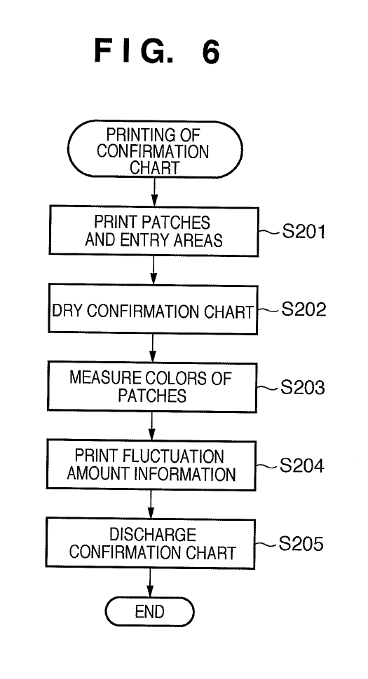

Details of the confirmation chart print processing in step S101 shown in FIG. 4 will be explained with reference to FIG. 6.

The printer 100 prints patches and entry areas corresponding to respective color gamuts (step S201). In the processing of step S201, patches 201 and entry areas 202 are printed out of the building elements of the confirmation chart 200 shown in FIG. 5. Note that a plurality of patches need not always be printed on the confirmation chart. The CPU 1 controls the print engine 6 (patch print control and entry-area print control) to print the patches 201 and entry areas 202. No entry area need be printed at the same time as printing patches in step S201.

Patches printed in the confirmation chart will be explained briefly.

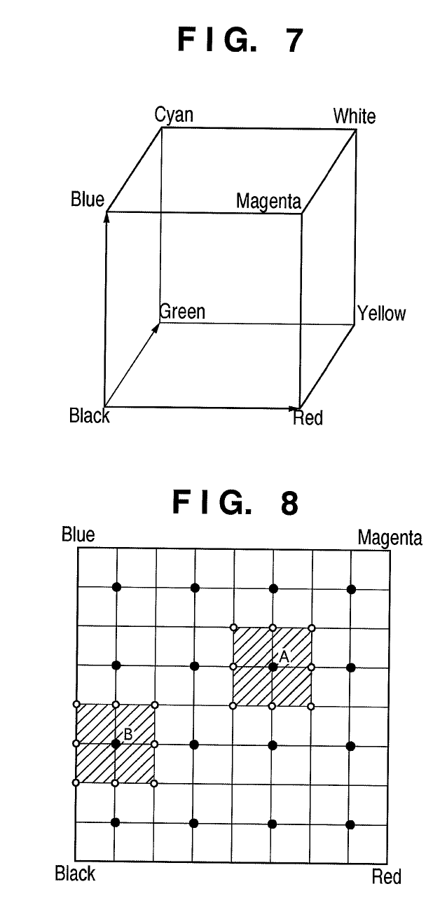

FIG. 7 shows the RGB color space. Colors corresponding to grid points obtained by dividing the 3D space at predetermined intervals are printed as patches. FIG. 8 is a view showing part of the schematic RGB color space shown in FIG. 7. For descriptive convenience, FIG. 8 shows grid points on a 2D plane of red and blue. In FIG. 8, axes including those at two ends on the red-blue plane are divided into nine grid points. An actual calibration 3D LUT is formed from, for example, 9×9×9=729 grid points.

It suffices to print, on the confirmation chart 200, not all patches corresponding to 729 grid points, but patches corresponding to four grid points • expressed on each axis in FIG. 8. In this case, 4×4×4=64 patches are printed. When a color gamut which need not be confirmed is known in advance, target color gamuts may also be limited in advance based on an instruction from the operator via the operation unit 3, display 2, or host computer 20.

When printing the confirmation chart 200, it suffices to process R, G, and B values corresponding to each grid as inputs of the 3D calibration processing 302 shown in FIG. 3. Accordingly, a patch chart is printed while reflecting the effect of the calibration 3D LUT.

Referring back to FIG. 6, the printer 100 waits until the colors of patches printed in step S201 stabilize, in order to dry the chart. For example, for a coloring material with high stability, such as pigment ink, the color stabilizes generally within a few minutes.

After the patch color stabilizes, the printer 100 uses the calorimeter 7 to measure the colors of all printed patches (step S203). At this time, in addition to control in the main scanning direction, the CPU 1 controls the calorimeter 7 to be able to measure the colors of target patches while reversely rotating the feed rollers 63 and 64 and feeding back paper in the sub-scanning direction. As a result, the colorimetry results of all patches are obtained as CIE L*, a*, and b* values.

Then, the printer 100 prints information (colorimetry result information) based on the colorimetry results of all printed patches in correspondence with the respective patches (step S204). More specifically, in the processing of step S204, colorimetry result information 203 is printed out of the building elements of the confirmation chart 200 shown in FIG. 5. The CPU 1 controls the print engine 6 (colorimetry-result print control) to print the colorimetry result information 203.

After printing, the printer 100 discharges the confirmation chart (step S205). When roll paper is used, it is cut into a predetermined size to discharge the confirmation chart.

The colorimetry result information 203 shown in FIG. 5 will be explained.

The colorimetry result information includes, for example, information (to be referred to as fluctuation amount information hereinafter) on a fluctuation amount from the reference state of a color gamut.

For example, numerical values representing a reference state can be L*, a*, and b* values obtained when previous calibration was executed, or designed L*, a*, and b* values representing the target characteristics of a printer.

The former values are effective for reducing a change of one printer over time. The latter values are effective for reducing fluctuations of the color tint depending on the individual difference between a plurality of printers, in addition to reducing a change over time. Either reference value set may also be permanently used in accordance with the application purpose of the printer, or the operator may also select either reference value set.

For example, when the color difference is used as fluctuation amount information, the color difference ΔE between a reference L*a*b* value and an L*a*b* value measured in step S203 is calculated, as is well known to those skilled in the art.

When the numerical value of the color difference is printed as fluctuation amount information, the print color or font may also be changed in accordance with the color difference level. For example, for a patch with a color difference ΔE of less than 2.0, information on the color difference is printed in normal black in correspondence with the patch. For a patch with a color difference ΔE of 2.0 or more, information on the color difference is printed in red boldface type in correspondence with the patch. This can improve the visibility of a greatly fluctuating patch. For a patch with a large color difference, a dedicated emphasis mark 204 such as ★ may also be printed near the patch, as shown in FIG. 5. This also improves the visibility of a greatly fluctuating patch.

The fluctuation amount information need not be the numerical value of the color difference, and may also be a graphical index such as a bar chart proportional to the color difference. As described above, the entry area 202 is provided near a patch and corresponding fluctuation amount information so that the operator can mark the entry area 202. The entry area desirably has any geometrical figure such as a rectangle or ellipse so that the user can mark it with a pen. The fluctuation amount information may also be measured L*, a*, and b* values. The measured L*a*b* value is effective information for an operator who wants to confirm detailed information.

As described above, the confirmation chart according to the embodiment explicitly represents the correspondence between a patch and its fluctuation amount, as shown in FIG. 5. The operator can easily grasp the fluctuation amount of a given color gamut. According to a conventional method, a dedicated calorimeter measures the colors of patches. The computer calculates the color differences between the measurement results and reference values, and the monitor displays a list of the color differences. The operator must confirm the correspondence between each color difference and each color on the chart and monitor. This may readily cause an error when confirming the correspondence. However, in the confirmation chart according to the embodiment, information on the fluctuation amount is printed near each patch in correspondence with the patch. This can suppress an error generated when confirming the correspondence.

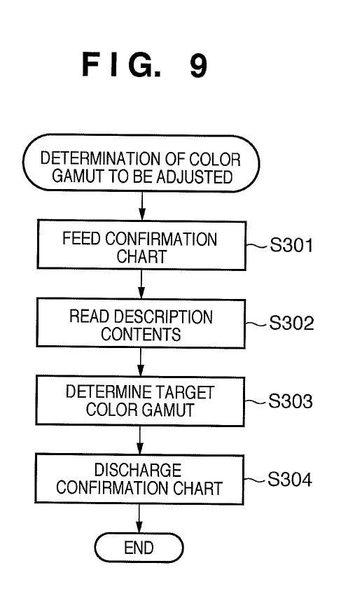

Details of the adjustment color gamut determination processing in step S103 shown in FIG. 4 will be explained with reference to FIG. 9.

In this processing, the operator sets a marked confirmation chart in the printer 100. The printer 100 feeds again the marked confirmation chart (step S301). The printer 100 positions the refed confirmation chart in the main scanning direction and sub-scanning direction. After positioning, the printer 100 uses the sensor 8 to read all the entry areas 202 provided in correspondence with patches on the confirmation chart (step S302).

In the printer 100, the CPU 1 monitors an output from the sensor 8. When the sensor 8 outputs a density value equal to or larger than a predetermined threshold, the CPU 1 determines that information corresponding to this density value is one described by the operator. Not the sensor 8, but the calorimeter 7 may also read information described by the operator. Not the printer 100, but another device such as the scanner 30 shown in FIG. 1 may also read information described by the operator. In this case, the scanner 30 scans a confirmation chart marked by the operator, and outputs the scanned image to the host computer 20. The host computer 20 analyzes the scanned image in accordance with a predetermined program, reading contents described by the operator. The host computer 20 transfers the read result to the printer 100 via the communication line 10.

Based on the description by the operator, the printer 100 determines a color gamut for which the calibration 3D LUT is to be updated (step S303). For example, when the operator marks patches corresponding to grid points A and B shown in FIG. 8, the printer 100 determines, as color gamuts to be updated, regions (hatched regions) surrounded by peripheral grid points. Finally, the printer 100 discharges the confirmation chart (step S304).

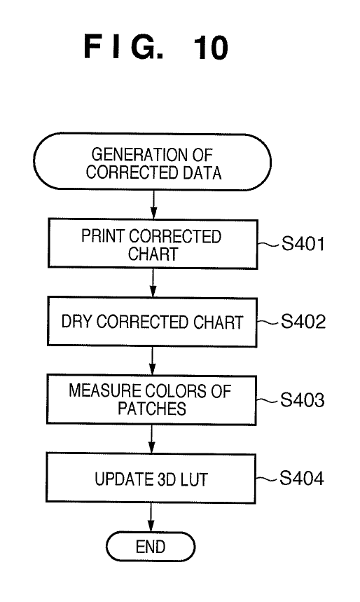

Details of the corrected-data generation processing in step S104 shown in FIG. 4 will be explained with reference to FIG. 10.

The printer 100 prints, as the second chart, a corrected chart in which patches corresponding to a plurality of grid points are laid out (step S401). The CPU 1 controls the print engine 6 (patch print control) to print each patch in the corrected chart. For example, when regions (hatched regions) containing grid points A and B shown in FIG. 8 are color gamuts to be updated, patches corresponding to all grid points in these regions are printed. In this case, for example, 3×3×3=27 patches are printed per region. For two regions respectively containing grid points A and B, 27×2=54 patches are printed. To widen the adjustment region, patches corresponding to grid points including surrounding ones may also be printed. For example, 5×5×5=125 patches may also be printed per region.

When printing the corrected chart, the operator who has confirmed the printer state in advance limits color gamuts to be adjusted, so the number of patches to be printed decreases. If the operator does not limit color gamuts, 9×9×9=729 patches in the 3D space need to be printed in correspondence with all grid points shown in FIG. 8. If the number of color gamuts to be adjusted is limited to N, the number of patches is limited to N×3×3×3 (for N=2, 54 patches) or less, or N×5×5×5 (for N=2, 250 patches) or less.

When printing the corrected chart, it suffices to process R, G, and B values corresponding to each grid as inputs of the 3D calibration processing 302 shown in FIG. 3. Accordingly, a patch chart is printed while reflecting the effect of the calibration 3D LUT. The coordinates of R, G, and B values used to measure colors on a patch chart and obtain the output values of respective grid points suffice to be calculated using coordinate values to which the calibration 3D LUT is applied. When R, G, and B values corresponding to each grid are processed as inputs of the color separation processing 303 shown in FIG. 3, the patch chart can be printed without the effect of the calibration 3D LUT. In this case, the coordinates of R, G, and B values used to measure colors on a patch chart and obtain the output values of respective grid points suffice to be calculated using R, G, and B values to which correction based on the calibration 3D LUT is not applied.

After that, the printer 100 waits until the colors of patches printed in step S401 stabilize, in order to dry the chart, as described above (step S402).

After the colors of patches stabilize, the printer 100 measures the colors of all printed patches (step S403). At this time, in addition to control in the main scanning direction, the CPU 1 controls the calorimeter 7 to be able to measure the colors of target patches while reversely rotating the feed rollers 63 and 64 and feeding back paper in the sub-scanning direction. As a result, the colorimetry results of all patches are obtained as CIE L*, a*, and b* values.

Based on the colorimetry results, the printer 100 updates the calibration 3D LUT (step S404).

For each grid point in a color gamut to be adjusted, R, G, and B values serving as the target values of a grid point of interest are obtained by interpolation calculation from the R, G, and B values of peripheral grid points based on the relationship between the calorimetric values of four grid points which form a tetrahedron containing the grid point of interest, and the reference values (target values) of the grid point of interest. Note that measurement values may not be the calorimetric values of four grid points, but may also be the measurement values of eight grid points which form a cube. Values obtained by the interpolation calculation serve as corrected output values of the grid point of interest. By interpolation calculation, correction is executed for all grid points to be adjusted. The calibration 3D LUT corrected in this manner is updated and stored in the storage 12.

In some cases, the patch chart may also be printed, dried, and undergo colorimetry while applying an updated calibration 3D LUT. In this case, a final confirmation chart in which information obtained as a result of colorimetry is printed near each patch is printed. By printing the final confirmation chart, the operator can correctly grasp color immediately after calibration. The final confirmation chart need not have an entry area for the operator.

As described above, the embodiment prints a confirmation chart in which measured colorimetry result information corresponds to each patch. The operator can easily grasp the fluctuation amount of a given color gamut, reducing an error caused by the operator.

An entry area is provided in correspondence with each patch, and a color gamut to be adjusted is determined in accordance with the description contents. The operator can easily determine a color gamut to be adjusted based on the correspondence between fluctuation amount information (e.g., color difference calculation result) and each patch. This facilitates the intervention of the user, and can reduce an error.

Color gamuts to be calibrated in accordance with a multi-dimensional LUT can be limited effectively. The number of patches to be printed can be decreased, the time taken for calibration can be shortened, and the amount of ink consumed can be reduced.

Typical embodiments of the present invention have been described above. However, the present invention is not limited to the aforementioned and illustrated embodiments, and can be properly modified without departing from the scope of the invention.

The above-described processing may also be executed using, instead of the printer 100, an apparatus (e.g., copying machine) having the functions of a scanner unit, printer unit, and the like, or an apparatus (e.g., multi-functional peripheral) having the functions of a facsimile unit and the like in addition to the above-mentioned functions. When the copying machine, multi-functional peripheral, or the like is used, it is also possible to read a confirmation chart using the copy function, synthesize the read patch chart image and information on the fluctuation amount such as the color difference, and output the synthesized image.

The above-described embodiment has exemplified the inkjet printer 100. However, the printing method is not limited to the inkjet method, but may also be another method such as an electrophotographic method or thermal transfer method, as described above.

In the above-described embodiment, the interval between grid points is set large in forming a confirmation chart. However, if the operator wants to grasp fluctuations of the printer in more detail, a patch chart can be formed at a smaller grip point interval.

In the above-described embodiment, the printer 100 incorporates the calorimeter 7, but the calorimeter 7 is not limited to this. For example, the calorimeter 7 may also be arranged outside the printer 100 (e.g., an external calorimeter may also be adopted). In this case, a colorimetry result obtained by the external calorimeter is input to the printer 100 via the communication line 10 and communication interface 9, thereby implementing processing described in the embodiment.

The present invention can adopt embodiments in the forms of, for example, a system, apparatus, method, program, and storage medium. The present invention may be applied to either a system constituted by a plurality of devices, or an apparatus consisting of a single device.

The present invention includes a case wherein the functions of the aforementioned embodiments are achieved when a software program is directly or remotely supplied to a system or apparatus, and a computer incorporated in that system or apparatus reads out and executes the supplied program codes. The program to be supplied in this case is a computer program corresponding to the illustrated flowcharts in the embodiments.

Therefore, the program codes themselves installed in a computer to implement the functional processing of the present invention using the computer also implement the present invention. That is, the present invention includes the computer program itself for implementing the functional processing of the present invention. In this case, the form of program is not particularly limited, and an object code, a program to be executed by an interpreter, script data to be supplied to an OS (Operating System), and the like may be used as long as they have the functions of the program.

As a computer-readable storage medium for supplying the computer program, various media can be used. As another program supply method, the user establishes connection to a website on the Internet using a browser on a client computer, and downloads the computer program of the present invention from the website onto a recording medium such as a hard disk.

The functions of the aforementioned embodiments can be implemented when the computer executes the readout program. In addition, the functions of the aforementioned embodiments may be implemented in collaboration with an OS or the like running on the computer based on an instruction of that program. In this case, the OS or the like executes some or all of actual processes, which implement the functions of the aforementioned embodiments.

According to the present invention, information based on the colorimetry results of one or a plurality of patches is printed on a patch chart in correspondence with the respective patches. The patch chart allows the user to more easily grasp color fluctuations in each color gamut than in a case wherein no patch chart is used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-134652 filed on May 22, 2008, which is hereby incorporated by reference herein in its entirety.

What is claimed is:

1. A printing system including a printing apparatus having a printing unit which prints on a printing medium, the system comprising:
a patch print control unit configured to control the printing unit to print at least one patch on the printing medium;
a colorimetry unit configured to measure a color of the patch which has been printed on the printing medium under control of said patch print control unit; and
a colorimetry-result print control unit configured to control the printing unit to print information based on a colorimetry result of the patch by said colorimetry unit in correspondence with the patch on the printing medium, thereby forming a first chart.

2. The system according to claim 1, further comprising an entry-area print control unit configured to control the printing unit to print, in correspondence with at least a patch which typifies each color gamut among patches of the first chart, an entry area for describing by an operator whether to adjust a color gamut.

3. The system according to claim 2, further comprising a determination unit configured to determine, based on information described in the entry area of the first chart, whether a patch corresponding to the entry area represents a color gamut to be adjusted,
wherein said patch print control unit controls the printing unit to print, on another printing medium, at least one patch corresponding to a color gamut determined by said determination unit to be adjusted, thereby forming a second chart.

4. The system according to claim 3, further comprising an update unit configured to update a multi-dimensional look-up table used in color conversion for adjusting a color tint of printing by the printing unit based on a colorimetry result of a patch of the second chart by said colorimetry unit.

5. The system according to claim 1, wherein when forming the first chart, said patch print control unit controls printing of the patch by the printing unit excluding a patch corresponding to a predetermined color gamut.

6. The system according to claim 1, wherein colorimetry by said colorimetry unit is performed by a calorimeter incorporated in the printing apparatus.

7. The system according to claim 1, wherein colorimetry by said colorimetry unit is performed by a colorimeter arranged outside the printing apparatus.

8. A printing apparatus having a printing unit which prints on a printing medium, the apparatus comprising:
a patch print control unit configured to control the printing unit to print at least one patch on the printing medium;
a colorimetry unit configured to measure a color of the patch which has been printed on the printing medium under control of said patch print control unit; and
a colorimetry-result print control unit configured to control the printing unit to print information based on a colorimetry result of the patch by said colorimetry unit in correspondence with the patch on the printing medium, thereby forming a chart.

9. A computer-readable storage medium storing a computer program, the program causing a computer incorporated in a printing apparatus having a printing unit which prints on a printing medium, to function as
a patch print control unit configured to control the printing unit to print at least one patch on the printing medium, and
a colorimetry-result print control unit configured to control the printing unit to print, in correspondence with the patch on the printing medium, information based on a colorimetry result of the patch by a calorimeter incorporated in the printing apparatus, thereby forming a chart.

10. A calibration method for a printing unit which prints on a printing medium, the method comprising:
controlling the printing unit to print at least one patch on the printing medium;
measuring a color of the patch which has been printed on the printing medium in the controlling the printing unit; and
controlling the printing unit to print, in correspondence with the patch on the printing medium, information based on a colorimetry result of the patch measured in the measuring a color of the patch, thereby forming a chart.
